(19) United States
(12) Patent Application Publication
(10) Pub. No.: US 2018/0252180 A1
(43) Pub. Date: Sep. 6, 2018

(54) METHOD FOR FORMING A COATING OF DUCT OF A CYLINDER HEAD AND CYLINDER HEAD THUS OBTAINED

(71) Applicants: MONTUPET S.A., Clichy (FR); SIFCO APPLIED SURFACE CONCEPTS, Saint-Thilbault-Des-Vignes (FR)

(72) Inventors: Patrick KERAMPRAN, Balaze (FR); Denis MASSINON, Compiegne (FR)

(21) Appl. No.: 15/756,976

(22) PCT Filed: Sep. 5, 2016
(86) PCT No.: PCT/EP2016/070897

§ 371 Date: Mar. 1, 2018

(30) Foreign Application Priority Data
Sep. 3, 2015 (FR) 1558180

(51) Int. Cl. F02F 1/42; F02F 1/00; C25D 11/00; C25D 11/02

(52) U.S. Cl. CPC F02F 1/4264; F02F 1/004; F05C 2203/0869; C25D 11/024; F05C 2253/12; C25D 11/005

(57) ABSTRACT

The invention relates to a method for forming a lining on the walls of an inner pipe of a cast aluminium-alloy part, including inserting a cathode into the pipe, circulating an electrolyte solution in said pipe between the cathode and the walls of the pipe forming an anode, and applying a potential difference between the anode and the cathode, the method being characterised in that applying the potential difference between the anode and the cathode includes applying a series of DC voltage pulses to the anode. The invention also relates to a cylinder head in which the exhaust pipes are lined with a lining obtained by implementing said method.

### FIELD OF THE INVENTION

The invention is directed towards a method for forming an aluminium oxide coating on walls of an inner duct of an engine cylinder head in aluminium alloy, and an engine cylinder head obtained with such a method.

### STATE OF THE ART

Engine cylinder heads are made of an aluminium alloy essentially for weight-saving reasons. The increased power-to-weight ratio of recently developed engines subjects cylinder heads to increasingly greater thermal stresses.

Good cooling of the cylinder head is obtained by integrating therein cooling circuits, more and more complex, formed when moulding the cylinder head through the use of sand cores.

To a certain extent, this allows to compensate for the temperature rise generated by the increased engine power-to-weight ratio, but proves to be ever more insufficient, and additionally requires modifying the geometry of the inner ducts of cylinder heads.

To further limit temperature rise in cylinder heads, electrochemical processes have been proposed allowing the formation of an oxide coating on the walls of the inner ducts of cylinder heads, e.g. the exhaust ducts, to limit heat exchanges between the cylinder head and the duct (e.g. the exhaust gases contained in the duct).

This first allows the cylinder head temperature to be reduced, and secondly allows an increase in the temperature of the gases leaving the cylinder head, thereby improving engine yield without impacting duct geometry.

For example, document WO 2013/38249 describes such a method for anodic oxidation of the exhaust duct walls of a cylinder head.

However, this method has the drawback that the coating obtained is porous on account of aluminium dissolution at the time of electrolysis. The presence of these porosities may generate initiated cracking, in particular when the cylinder head is exposed to usual engine operating temperatures that may reach 250° C. or higher.

This may result in leaks between the water circuits or of coolant in the immediate vicinity of the exhaust ducts to these ducts, which may ruin the engine.

It is therefore necessary to carry out post-treatment to seal the oxide coating, increasing the length and cost of the process.

Also, from document JP3944788 a method is known to coat the inner duct having a cylinder of revolution. The treatment disclosed in this document is described as allowing the imparting of good abrasion resistance to the inner surface of the cylinder whilst ensuring good lubrication. The oxide layer thus formed does not allow limiting of heat exchanges between the inside of the duct and the walls. In addition, the teaching of this document is limited to the treatment of a cylinder having extremely simple geometry, and the treatment of complex geometries is not at all envisaged.

Document US 2013/0146041 describes another method that does not mention the application of DC voltage pulses.

The method disclosed in this document is also limited to simple cylinder geometry. In document JP3944788 as in document US 2013/0146041, the surface to be coated therefore extends around a unitary volume.

Herein, and as illustrated in Figure A, a unitary volume is defined as a volume in which any segment connecting two points of the volume M and N by a straight line is an integral part of this volume (in other words: for any pair of points (M, N) in the volume, any point of the segment connecting these two points in a straight line also belongs to said volume). A complex volume having branches is therefore not a unitary volume.

The methods described in JP3944788 and US 2013/0146041 could not therefore be applied to complex geometries, in particular of a cylinder head.

Also, these methods are not able to provide aluminium oxide layers of low porosity and narrow thickness.

There is therefore a need for a solution whereby it is possible to limit heat exchanges between exhaust gases and a cylinder head, that does not have these disadvantages.

### PRESENTATION OF THE INVENTION

It is the objective of the invention to propose a method for forming an oxide coating in the inner ducts of a cylinder head, that does not have the drawbacks of the prior art.

In particular, it is one objective of the invention to allow the formation of an oxide coating not requiring postsealing treatment.

It is another objective of the invention to propose a method for forming an oxide coating allowing improved oxide quality to be obtained compared with the prior art.

A further objective of the invention is to propose a method for forming an oxide coating that is quicker to implement than in the prior art and compatible with mass production.

In this respect, the subject of the invention is a method for forming an oxide coating on walls of an inner duct of a cast part in aluminium alloy, comprising inserting a cathode in the duct, circulating an electrolyte solution in said duct between the cathode and the anode-forming walls of the duct, and applying a potential difference between the anode and the cathode, the method being characterized in that applying the potential difference between the anode and cathode comprises applying a series of DC voltage pulses to the anode.
Advantageously, but optionally, the method of the invention may also comprise at least one of the following characteristics:
each pulse of the series has a duration of between 0.01 and 0.02 s and two successive pulses are separated by 0.001 to 0.01 s.
the voltage applied to the anode varies over the series of pulses and is between 0 and 150 V to maintain a current density of between 10 and 50 A/dm² of surface to be treated.
the total duration of the series of pulses is between 30 and 300 s as a function of the type of alloy to be treated and the desired oxide thickness.
the electrolyte comprises 10 to 20% sulfuric acid and 1 to 5% ferrous sulfate.
the electrolyte flow rate in a duct is between 0.5 and 2.0 m³/h per dm² of surface to be treated.
the temperature of the electrolyte in a duct is between −10° C. and 0° C.
the cathode is shaped to match the shape of the inner duct(s) of the cast part, leaving a mean interstice of between 3 and 15 mm between the cathode and the duct wall.

A further subject of the invention is an engine cylinder head in aluminium alloy characterized in that, on the walls of at least one inner duct, it comprises a coating in aluminium oxide having a thickness of between 50 and 200 μm, adapted to ensure sealing and thermal insulation of the inner duct wall of the cylinder head when exhaust gases flow inside said duct at a temperature higher than 900° C.

Advantageously, the engine cylinder head is obtained by implementing the method described in the foregoing.

In one embodiment, the inner ducts of the cylinder head provided with an oxide coating are exhaust ducts of combustion products.

The use of pulsed currents when implementing anodization treatment of the cylinder head allows a coating of determined thickness to be obtained more rapidly.

In addition, pulsed currents also allow to obtain a coating of increased quality and non-porous. This coating therefore allows the seal of cylinder head ducts to be ensured, thereby obviating the need for plugging post-sealing treatment.

The use of a cathode having geometry conforming to that of the inner duct of the cylinder head to be coated allows homogeneous current lines to be generated over the entire duct, and hence a coating of homogeneous thickness on completion of treatment. It is to be noted that the geometry of cylinder head inner ducts is complex, as illustrated in FIG. 6. In this Figure, in cross-section, the presence is noted of multiple branches branching from a base opening and leading into the combustion chamber (not illustrated). Each branch extends from this base with different curvatures depending on their distance away from the axis of symmetry X-X of the structure, passing through the base opening. It will therefore be understood from this illustration that the obtaining of a coating having homogeneous thickness throughout the entire duct requires a treatment process which applies homogeneous current lines at all times. The method of the invention meets these needs.

The choice of composition of the electrolyte contributes towards reducing the porous nature of the coating and therefore contributes towards the sealed nature thereof.

By modulating the electrolyte flow rate, it is also possible to obtain best evacuation of the calories (Joules losses) generated by electrolysis, to limit the phenomenon of oxide layer dissolution occurring at the time this layer is generated. The holding of the electrolyte temperature within the desired range allows the quality of the coating layer obtained to be improved.

### DESCRIPTION OF THE FIGURES

Other characteristics, objectives and advantages of the invention will become apparent from the following description that is solely illustrative and nonlimiting, and is to be read in connection with the appended drawings in which, in addition to Figure A which illustrates the notion of unitary volume:

FIG. 1 schematically illustrates a system for implementing a method for forming a coating on a cylinder head conforming to one embodiment of the invention.

FIG. 2a illustrates inner ducts of a cylinder head, and FIG. 2b illustrates a cylinder head with integrated exhaust gas collector.

FIG. 3 illustrates a cathode shaped to match the shape of the inner ducts of a cylinder head.

FIG. 4 illustrates the changes in voltage applied to the cylinder head, and the current density between the anode and cathode when implementing the method for forming an insulating coating.

FIG. 5 gives an EDS analysis spectrum of the aluminium oxide deposited with the method.

FIG. 6 is an illustration in cross section of the geometry of a cylinder head inner duct for which the method to form a coating according to the invention is adapted.

FIG. 7a illustrates an observation section of the thickness of the anodization layer.

FIG. 7b illustrates another observation section of the thickness of the anodization layer.

### DETAILED DESCRIPTION OF AT LEAST ONE EMBODIMENT OF THE INVENTION

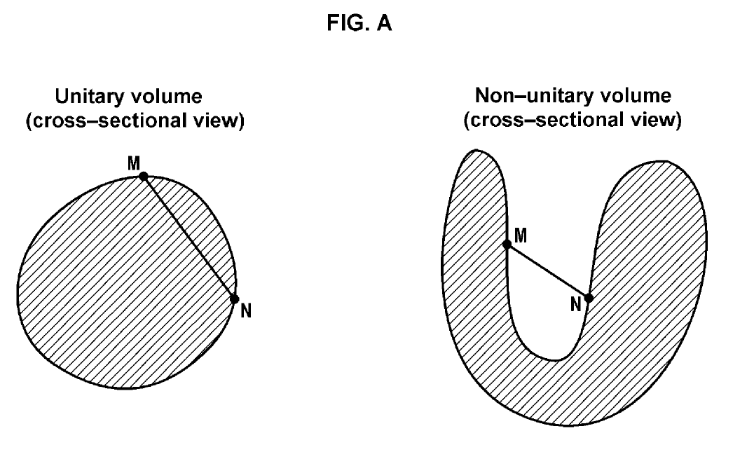

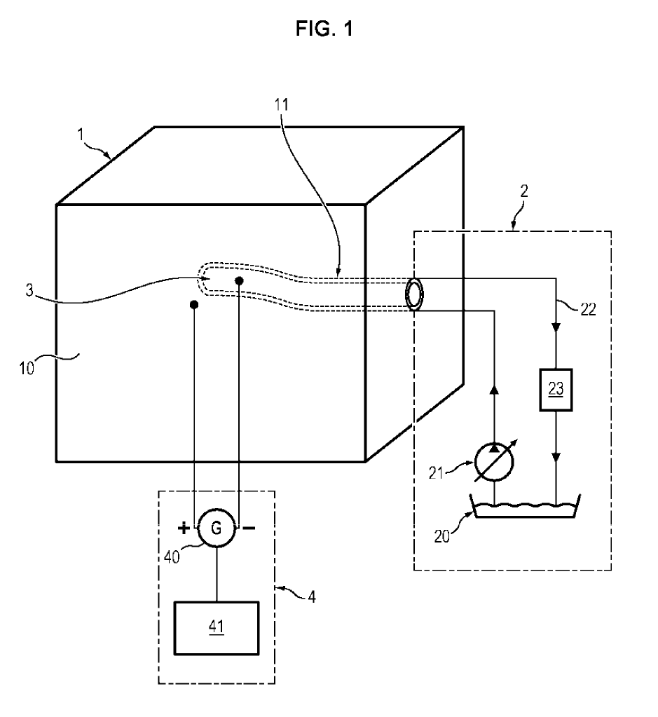

With reference to FIG. 1, a cast part 10 in aluminium alloy is schematically illustrated. This cast part is of complex geometry and particularly comprises cored inner ducts 11.

The constituent alloy of this cast part is aluminium-silicon based of hypo-eutectic type comprising less than 12.5 weight % of silicon and may contain alloying elements such as copper and magnesium.

As a nonlimiting example, the constituent alloy of this part 10 is of type AA319 or an alloy of type AA356.

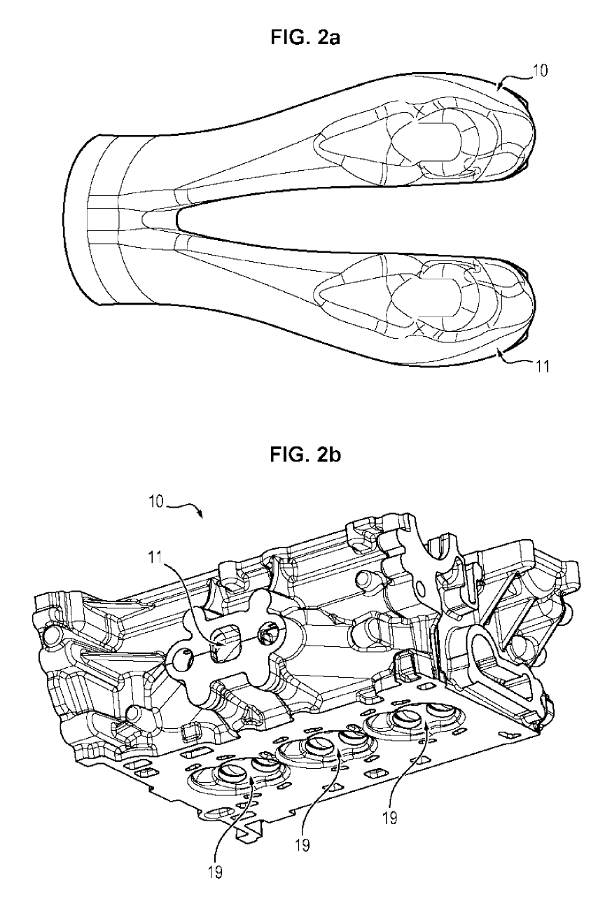

As illustrated in FIG. 2, the cast part is advantageously an engine cylinder head 10. In this case, the inner ducts 11 under consideration are advantageously exhaust ducts for combustion products. In this respect, the cylinder head 10 is advantageously a cylinder head comprising an integrated exhaust gas collector, as is the case for example for the cylinder head in FIG. 2b. FIG. 2b also illustrates the combustion chambers 19 of the cylinder head.

To limit heat exchanges between exhaust gases circulating in the duct 11, the temperature of which may exceed 900° C., and the part 10, a method is implemented to form an insulating coating 13 in aluminium oxide on the inner walls of each duct 11 via anodic oxidation.

The system 1 used to implement this method is illustrated in FIG. 1.

It comprises a cathode 3 arranged inside the cylinder head, a circulation circuit 2 of an electrolyte solution between the cathode and the anode-forming walls of the cylinder head, and a circuit 4 controlling the potential difference applied between the anode and cathode, said potential difference generating an oxidation reaction at the anode to form the oxide coating.

### Electrolyte Solution Circulation System

The system 2 for circulating the electrolyte solution in the cylinder head ducts 11 is illustrated in FIG. 1. It advantageously comprises a tank of electrolyte solution 20, a pump 21, and a closed circuit 22 circulating the solution between the tank and the ducts 11 of the cylinder head. The electrolyte solution preferably comprises between 10 and 20% sulfuric acid and from 1 to 5% ferrous sulfate.

To prevent dissolution of the oxide created by the method to form the coating, this dissolution being catalysed by the heat caused by electrolysis, the solution is advantageously held at a temperature of between −10° C. and 0° C.

In this respect, the circuit 2 advantageously comprises a member 23 to cool the electrolyte solution. In addition, the pump advantageously has a variable flow rate to modulate the electrolyte flow rate as a function of temperature.

Advantageously, the pump 21 is sized as a function of the surface area to be coated and thickness of the oxide layer to be grown and is advantageously adapted to circulate a flow of electrolyte solution in the cylinder head at a rate of between 0.5 and 2 m³ per hour and per square decimetre (/h·dm²) of surface to be treated.

The circulation of electrolyte in the ducts at a temperature of between −10 and 0° C. allows a homogeneous coating to be obtained.

### Arrangement of the Cathode

A cathode 3 is positioned inside exhaust ducts 11 of the cylinder head. This cathode is made of a material allowing redox reactions to take place in the electrolyte solution. In particular, the cathode is advantageously in stainless steel of 316L type for example.

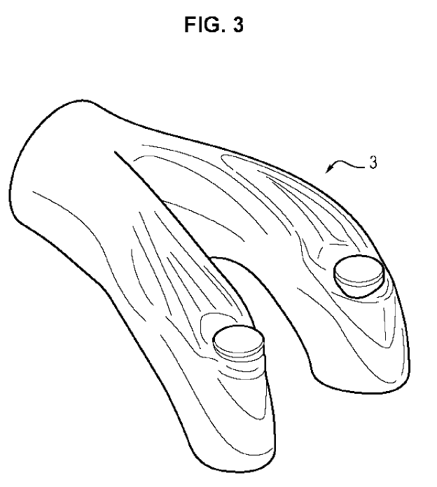

With reference to FIG. 3, the cathode 3 is advantageously shaped to match the shape of the ducts 11 leaving an interstice, preferably a constant interstice, between the cathode and the ducts, allowing circulation of the electrolyte. This makes it possible, when applying a potential difference between the anode and cathode, to set up homogeneous current lines over the entirety of the surface to be coated, and thereby obtain an identical growth rate of the layer on the surface. On completion of the method, this allows a layer of homogeneous thickness to be obtained on all the treated surfaces.

The mean interstice between the cathode and the wall of a duct is advantageously between 3 and 15 mm. This amounts to a good trade-off regarding the thickness to be maintained between the cathode and the wall of the duct 11, first to promote circulation of electrolyte and the entraining of gases generated by electrolysis, including when the oxide layer starts to be formed, and secondly to maintain sufficient current density to prevent slowing of oxide layer growth.

### Anodic Oxidation

Returning to FIG. 1, the system to implement the method for forming a coating layer on the ducts of the cylinder head 10 further comprises a circuit 4 to control the potential difference between the anode and cathode.

The circuit 4 comprises a voltage source 40, adapted to deliver a voltage to the anode-forming cylinder head 10, a control unit 41 controlling the voltage source, and one or more sensors (not illustrated) adapted to record the voltages between the anode and cathode, and the current between the anode and cathode, to allow the defined current to be obtained.

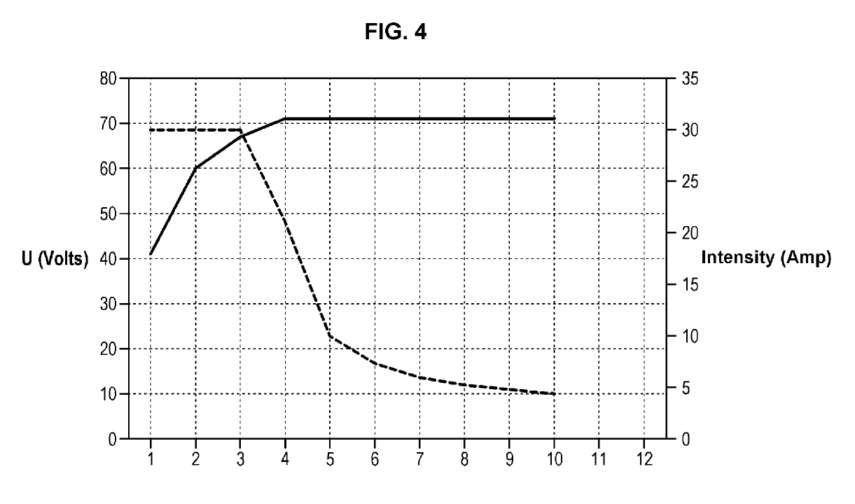

With reference to FIG. 4, to form the oxide layer 13 on the walls of the ducts 11, the control unit 41 drives the voltage source 40 to deliver a series of DC voltage pulses to the anode.

The frequency of the voltage pulses is advantageously higher than 10 Hz, preferably between 10 and 50 Hz.

More specifically, each voltage pulse has a duration of less than 0.1 second, and preferably of between 0.01 and 0.02 second, during which time the value of the applied voltage is constant. Each pulse is also separated from the following pulse by a nonzero time interval of less than 0.1 second, preferably less than 0.01 second, and advantageously between 0.001 and 0.01 second. During this time interval, the voltage applied to the anode is therefore zero.

The application of such a series of voltage pulses allows a reduction in the time needed to implement the method by promoting evacuation of Joules losses and gases.

By way of comparison, the obtaining of an oxide layer having a thickness of between 50 and 200 μm requires a treatment time in the order of 70 seconds, whilst the time required in the prior art is in the order of several minutes.

In addition, the values of the voltage of each pulse change progressively as and when the oxide layer is formed. Indeed, on account of its insulating nature, the oxide layer opposes the setting up of a current between the anode and cathode.

In particular, the guiding of the voltage source 40 by the control unit 41, is determined by the value of the current density between the anode and cathode. Measurement of the current by the sensors enables the control unit 41 to calculate the current density and, as a function of the result, to drive the value of the voltage delivered by the voltage source 40.

To maintain sufficient current density for continued growth of the layer, the voltage globally increases over the series of pulses. The desired current density is advantageously between 5 and 50 A/dm² of surface to be treated.

Therefore, the value of the voltage of each pulse is between 0 and 150 V, advantageously between 0 and 120 V, the pulses occurring in the first seconds e.g. the first 5 or 10 first seconds of the method having a voltage of between 0 and du 50 V, and the following pulses advantageously having an increasing voltage up until sufficient voltage to maintain a current density that is advantageously higher than 5 A/dm², preferably higher than 10 A/dm². This maximum voltage is advantageously between 70 and 150 V, preferably between 70 and 120 V.

This series of DC voltage pulses at the anode is performed for a time of between 30 and 300 s as a function of the type of alloy to be treated and the thickness of the oxide layer it is desired to obtain.

Therefore, the application of a potential to the anode generates a potential difference between the cylinder head and the cathode and causes chemical reactions which, on the aluminium of the cylinder head, produce aluminium oxide on the walls of the exhaust ducts 11.

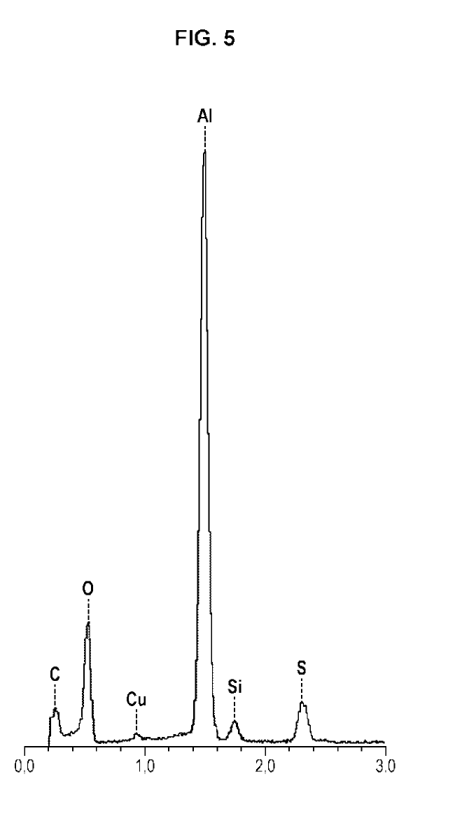

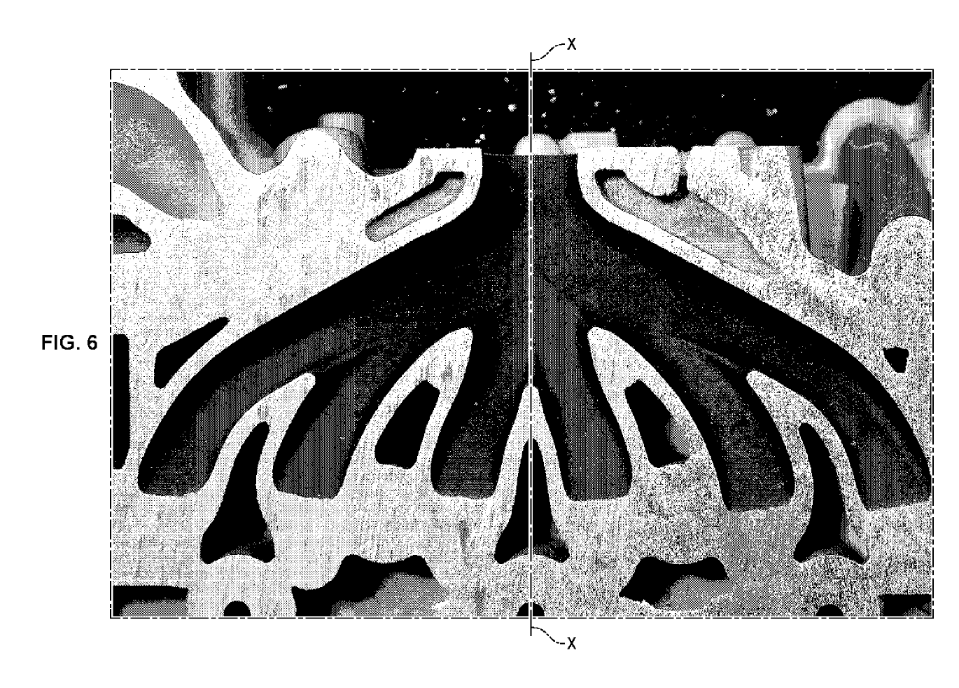

FIG. 5 illustrates an EDS analysis spectrum (Energy Dispersive Spectroscopy) performed on the aluminium oxide obtained. The relative heights of the peaks of this spectrum indicate an oxide composition having close stoichiometry to that of alumina Al₂O₃, the other components being pollutants derived from the electrolyte composition.

So that the oxide layer 13 can ensure insulation of the cylinder head when in operation i.e. when gases having a temperature of 950° C. flow inside the inner ducts, the oxide layer formed on each inner duct advantageously has a thickness of between 50 and 200 μm. This thickness varies chiefly as a function of the silicon and copper concentration of the treated aluminium alloy. However, it remains sufficiently thin so as not to alter the dimensional characteristics of the product within a tolerance margin of ±0.5 mm.

It has been evidenced that application of type T7 heat treatment i.e. comprising solution treatment at a temperature of between 490 and 540° C. (depending on the aluminium alloy used), quenching in water or air and annealing at a temperature of 200° C. or higher, allows more homogeneous coating layers to be obtained in terms of thickness and density.

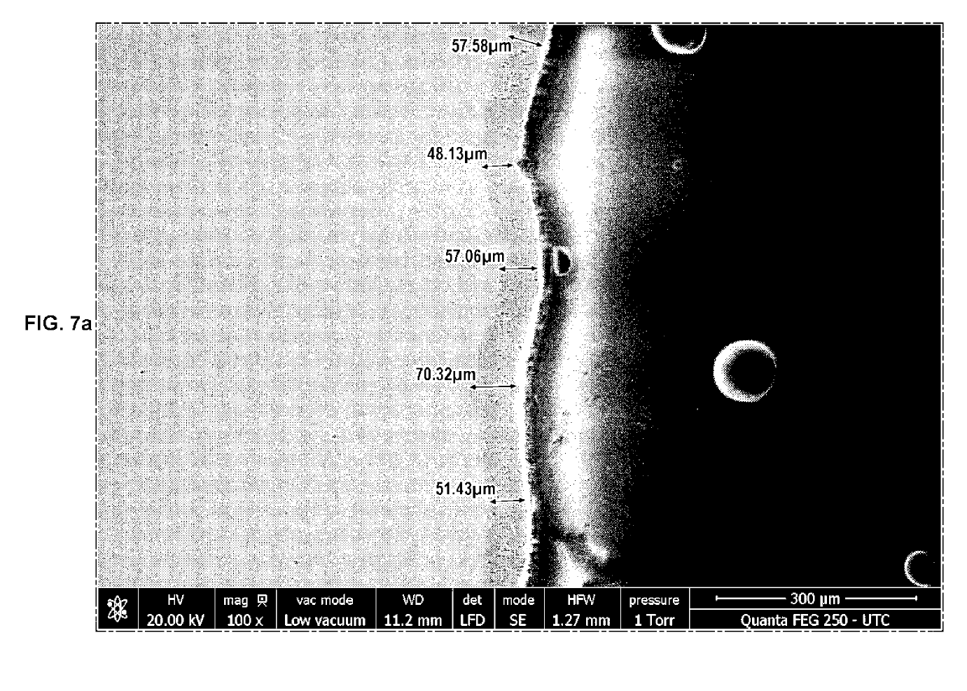

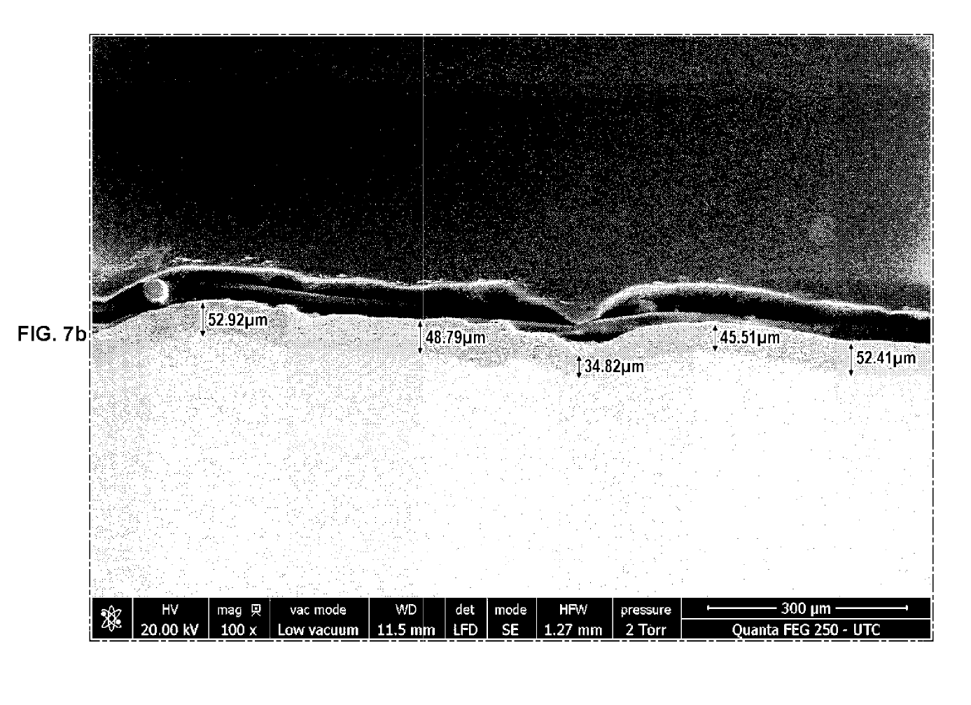

As a nonlimiting illustration, FIGS. 7a and 7b give cross-sectional views of an oxide coating on a cylinder head obtained after treatment following the method of the invention. In these illustrations, the oxide layer is between 34.92 μm and 70.32 μm and has maximum porosity of 15%. By porosity is meant an overall void percentage within the oxide layer.

Good layer density is therefore obtained as well as a narrow thickness. It is therefore no longer necessary to carry out post-sealing treatment, re-machining or finishing. In addition, the described method leads to cycle times that are compatible with mass production in the automotive sector (i.e. 5 to 6 min).

The proposed method, within short time, therefore allows an insulating coating to be obtained of homogeneous thickness on inner ducts of parts in aluminium alloy such as engine cylinder heads.

1. A method for forming an aluminium oxide coating on walls of an inner duct of a cast part in aluminium alloy,
the method comprising inserting a cathode in the duct, circulating an electrolyte solution in said duct between the cathode and the anode-forming walls of the duct, and applying a potential difference between the anode and the cathode,
the method being characterized in that applying the potential difference between the anode and cathode comprises applying a series of DC voltage pulses to the anode.

2. The method for forming according to claim 1, wherein each pulse of the series has a duration of between 0.01 and 0.02 s and two successive pulses are separated by 0.001 to 0.01 s.

3. The method for forming according to claim 1, wherein the voltage applied to the anode varies over the series of pulses and is between 0 and 150 V to maintain a current density of between 10 and 50 A/dm² of surface to be treated.

4. The method for forming according to claim 1, wherein the total duration of the series of pulses is between 30 and 300 s as a function of the type of alloy to be treated and the desired oxide thickness.

5. The method for forming according to claim 1, wherein the electrolyte comprises 10 to 20% sulfuric acid and 1 to 5% ferrous sulfate.

6. The method for forming according to claim 1, wherein the electrolyte flow rate in a duct is between 0.5 and 2.0 m³/h per dm² of surface to be treated.

7. The method for forming according to claim 1, wherein the temperature of the electrolyte in a duct is between −10° C. and 0° C.

8. The method for forming according to claim 1, wherein the cathode is shaped to match the shape of the inner duct(s) of the cast part, leaving a mean interstice of between 3 and 15 mm between the cathode and the duct wall.

9. An engine cylinder head in aluminium alloy, wherein, on the walls of at least one inner duct, it comprises a coating in aluminium oxide having a thickness of between 50 and 200 μm, adapted to ensure sealing and thermal insulation of the inner duct wall of the cylinder head when exhaust gases flow inside said duct at a temperature higher than 900° C.

10. The engine cylinder head according to claim 9, the cylinder head being obtained by implementing a method forming an aluminium oxide coating on walls of an inner duct of a cast part in aluminium alloy,
the method comprising inserting a cathode in the duct, circulating an electrolyte solution in said duct between the cathode and the anode-forming walls of the duct, and applying a potential difference between the anode and the cathode, and
the method being characterized in that applying the potential difference between the anode and cathode comprises applying a series of DC voltage pulses to the anode.

11. The engine cylinder head according to claim 9, wherein the inner ducts provided with an oxide coating are exhaust ducts of combustion products.

12. The engine cylinder head according to claim 10, wherein the inner ducts provided with an oxide coating are exhaust ducts of combustion products.
